(19) United States
(12) Patent Application Publication
(10) Pub. No.: US 2008/0191967 A1
(43) Pub. Date: Aug. 14, 2008

(54) Passive display with planar interconnect

(75) Inventor: Karl Spyros Papadantonakis, Pasadena, CA (US)

Correspondence Address: Karl Papadantonakis, 1033 Cordova St. #19, Pasadena, CA, 91106, US

(73) Assignee: Karl Spyros Papadantonakis, Pasadena, CA (US)

(21) Appl. No.: 11/673,710

(22) Filed: Feb. 12, 2007

(51) Int. Cl. G09G 3/20

(52) U.S. Cl. 345/33

(57) ABSTRACT

Disclosed is an electrical display system using novel single plane interconnect. All display elements are individually addressable using three state driving, meaning that each signal can be high, low, or off. Furthermore, a method is given to generate planar display interconnect via tile selection and quilting that is guaranteed to allow individual addressability when the resulting display is used with three state driving.

### BACKGROUND OF THE INVENTION

The invention is a type of passive display system. In such systems [U.S. Pat. No. 4,602,292] many display elements are connected via some interconnect structure that reduces the number of terminals which must connect from the external driver to the display. The display is passive, meaning that only wires and passive display elements but no logic or amplifying elements exist inside the display portion.

Traditional passive display interconnect is designed for row/column addressing [U.S. Pat. No. 4,602,292]. For example, interconnect for multi-digit displays can be made (FIG. 2). The problem with all row/column interconnect is that it is mathematically impossible to make it planar. I.e., wires must cross one another regardless of the geometric embedding of the interconnect topology. Therefore multiple planes must be used, and this increases system cost.

A more versatile yet less commonly used form of addressing is based on three state signaling [U.S. Pat. No. 4,319,227]. Three state signaling reduces the number of terminals between the display and driver.

While three state signaling can be readily applied to displays whose elements are arranged in a plane, the resulting interconnect is generally far from planar. In fact, the number of wire crossings is generally much higher for three state addressing than it is for row/column addressing. For example, the canonical interconnect topologies for three state signaling cannot be arranged into planar geometries because they have more connections per terminal than row/column interconnect.

Finally, there exist many technologies for building large circuits by arraying or quilting smaller tiles [U.S. Pat. No. 6,491,560]. To make such technology work with a new kind of interconnect, the interconnect must have the same array or quilt structure as the display elements themselves. This problem has also not been previously addressed in a way that would yield single plane interconnect for passive displays.

### REFERENCES CITED

### U.S. Patents

[U.S. Pat. No. 4,319,227] Three state signaling system

[U.S. Pat. No. 4,602,292] Driving system for matrix display device

[U.S. Pat. No. 6,491,560] Array tile system and method of making same

### BRIEF SUMMARY OF THE INVENTION

The invention comprises a passive multi-element display with planar interconnect, together with a driver that can address any element in the display using three state signaling. The purpose of the invention is to reduce interconnect cost without reducing display functionality.

The display is operated by addressing elements or groups thereof using three state signaling in rapid sequence so that any pattern can be displayed.

The display has many possible embodiments. In all forms, the interconnect is designed to achieve some desired arrangement of the display elements. For example, a simple but novel interconnect for the popular seven element arrangement is shown in FIG. 1. This tile has 5 terminals connecting to the driver, and 7 individually addressable display elements.

Other, larger embodiments are formed by using the aforementioned interconnect geometry as a tile in a larger array (FIG. 3). In this form, each additional tile provides 7 individually addressable display elements, but requires only 3 additional terminals to connect to the driver. Therefore this example satisfies the restrictions of claim 3.

Additional embodiments are formed by quilting the 7-segment tile with other tiles as shown in FIG. 5. In this example each addressable element consists of two parallel-wired LEDs.

Embodiments are not limited to numerical displays. In FIG. 4, two possible tiles for a matrix display are shown. FIG. 4a shows interconnect having 6 terminals including a common outer terminal. The interconnect shown in FIG. 4b has just 5 terminals. Therefore claim 2 is satisfied for this tile on its own. Furthermore, of the 5 terminals, just 3 terminals per additional tile are required in large arrays.

In some of the preceding examples, the display element is an LED or parallel-wired group of LEDs. However the invention is not limited to LEDs. In fact any display element with nonlinear voltage-dependent output will meet the operational requirements of three state signaling. For example, gas discharge tubes also have a highly nonlinear output. However in this case series wiring should be used instead of parallel wiring to combine multiple devices per display element.

None of the embodiments shall be construed as being preferred over another. Other embodiments satisfying the claims that have not been specifically listed are possible. A general method for finding these other embodiments is given in the detailed description.

### BRIEF DESCRIPTION OF THE SEVERAL VIEWS OF THE DRAWING

FIG. 1: Example Planar Interconnect for Digit Tile

This is an example of novel planar interconnect geometry for a digit tile. The tile has left and right boundaries which can connect either to exact copies of the same tile (arraying) or to different tiles (quilting). The elements may be either polarized or unpolarized in this case. All 7 elements are individually addressable. There are 5 terminals: G, C0, C1, A, and B.

FIG. 2: Example Array using Row/Column Interconnect

This is an example of prior art. A tile is arrayed using row/column interconnect that cannot be made planar. Each tile has a common cathode (1 . . . 2) corresponding to the column. Each segment within the tile has an anode (A . . . G) corresponding to the row.

FIG. 3: Example Array using Planar Interconnect

This example shows how larger displays with planar interconnect can be formed by arraying the tile shown in FIG. 1 three times. All 21 display elements are individually addressable. This figure illustrates that each additional tile (numbered i) provides 7 additional individually addressable display elements, but requires only 3 additional terminals to connect to the driver: Ai, Bi, and Ci.

FIG. 4: Example Planar Interconnect for Matrix Tile using LEDs

This example shows tiles for a regular 4×4 array of display elements having planar interconnect. FIG. 4a shows interconnect having 6 terminals including a common outer terminal, while the interconnect shown in FIG. 4b has just 5 terminals.

FIG. 5: Example Quilt using LEDs

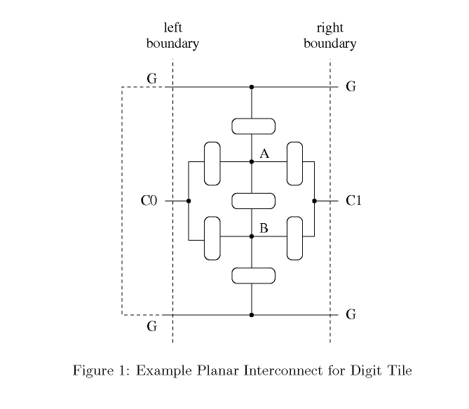

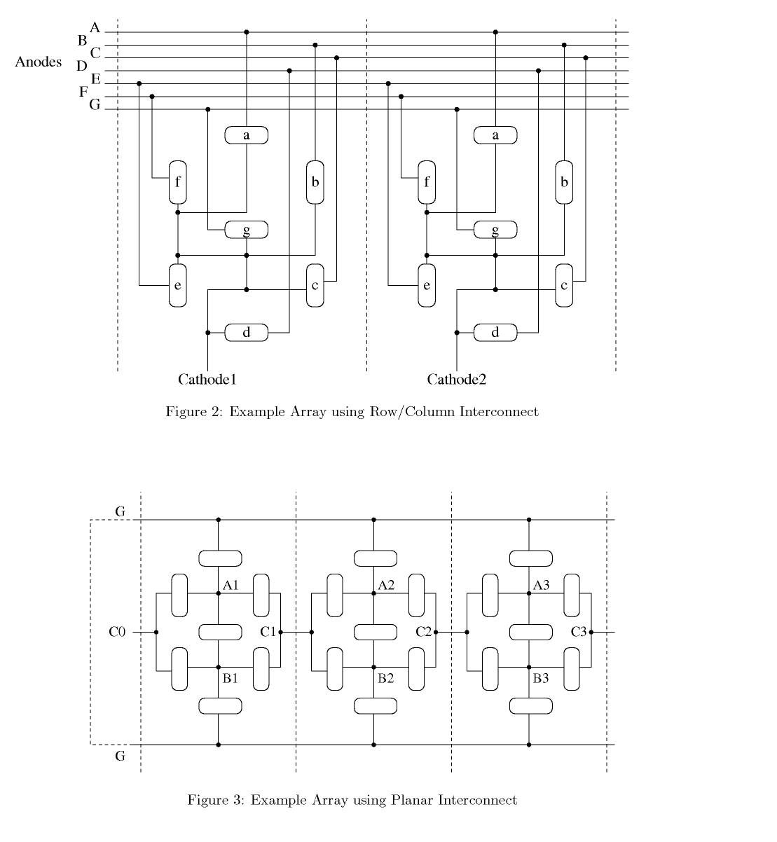

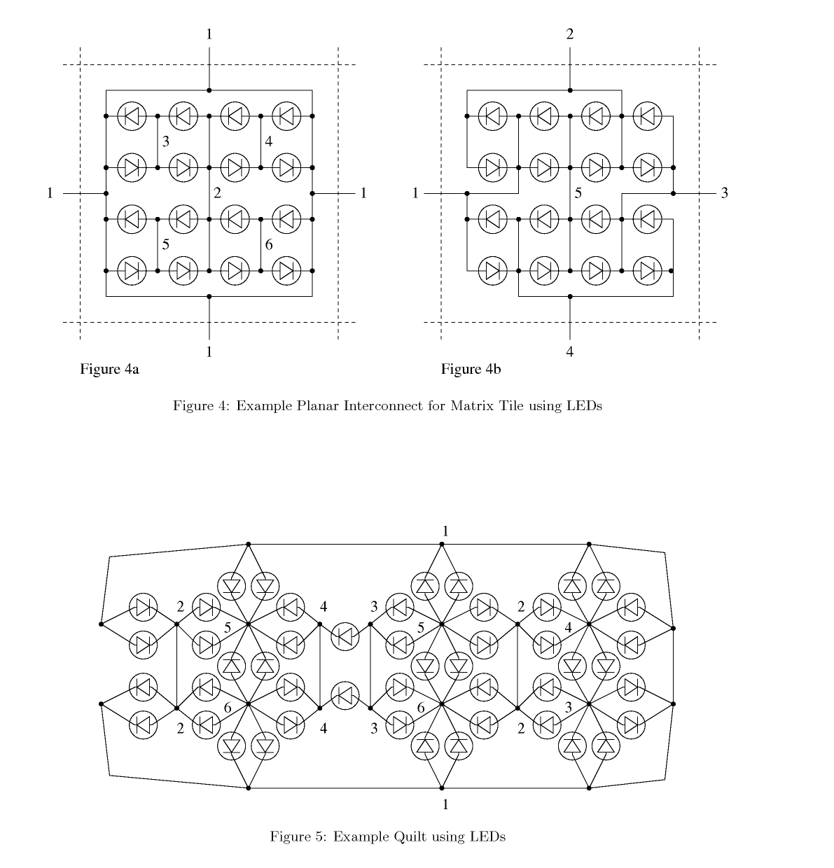

This example is a quilt formed using the tile shown in FIG. 1 and parts thereof. Each display element is a pair of parallel-wired LEDs. Terminals are numbered to show possible external connections to reduce driver complexity. Any two terminals with the same number may be externally connected without reducing functionality.

### DETAILED DESCRIPTION OF THE INVENTION

To make and use the invention, three steps are required. First, a planar interconnect geometry must be chosen for the display. Second, a driver must be designed to address the display. Finally, the display and driver must be physically implemented. First, a planar interconnect geometry must be chosen. The topology of this geometry must satisfy the requirements of three state signaling. Three state signaling works whenever the elements have voltage-dependent output and no two elements are connected to the same pair of terminals. If the elements are polarized then a maximum of two elements may be connected to the same pair of terminals; in this case the elements must be connected with opposing polarity.

A general method of building a geometry of arbitrary size and complexity is quilting. Therefore the focus will be on choosing quiltable tiles; i.e., tiles that can be combined by abutment on arbitrary sides yet still yield a quilt that satisfies the electrical requirement for three state signaling.

The quilt as a whole cannot have more than two elements connecting any pair of terminals. I.e., for any pair of terminals, at most two elements connect directly between them. This property must hold both for two terminals within the same tile, and for two terminals in different tiles.

If arbitrary abutment is desired, then a discipline is needed to ensure that two tiles will not abut in some way that violates the property. Clearly this problem occurs only when two terminals are on the same side of a tile. One possible discipline is to allow only one element between the terminals (or none if the elements are unpolarized) in this case. This is the case in the interconnect geometry shown in FIG. 1. In the arrayed form (FIG. 3) the property is satisfied as a result of using this discipline.

After an interconnect geometry has been chosen, the desired elements must be inserted into this geometry to form a complete circuit. One example of such a circuit is shown in FIG. 5. As a first test, this circuit should be built to verify that each element is individually addressable. When sufficient voltage is applied across each element, then that element illuminates while no other element illuminates as much or at all. This experiment should first be done on all elements, one element at a time.

If desired, the number of terminals may first be reduced by externally connecting some terminals outside of the display wiring plane. In FIG. 5, all terminals labeled with the same number may be externally connected. If this is done then the preceding addressability experiment should be repeated.

After this example has been verified, the other tile examples and several quilts formed thereof should be tested. As an alternative to quilting, new tiles may be formed by searching the space of small planar graphs and removing display elements that violate the property of two elements per terminal pair. In each case, individual addressability should be checked. At this point the engineer understands the principle and is ready to choose his own interconnect satisfying the properties explained above.

After a display has been built, a driver must be designed and built. Most micro-controllers provide three state outputs that can be directly connected to the display. However, there are three major practical issues: false positives, current drive, and drive duty.

The issue with false positives is that some LEDs that are not intended to be selected may illuminate. This problem is solved by ensuring that the driver output voltage is always between 1× and 2× the LED starting voltage. That way, deselected LEDs will not have sufficient voltage to illuminate. For most LEDs this restriction does not significantly reduce the maximum brightness.

Current drive is solved by selecting an appropriate amplifier. The challenge is to find an amplifier that preserves the three state signaling. There are several textbook solutions to this problem that I have tested successfully. The simplest is to use an external three state driver. Other solutions involving finite-gain amplifiers are more cost effective because fewer microcontroller pins are needed.

To display an arbitrary pattern, elements are driven in a rapidly repeated sequence. This results in a drive duty problem: each element is not enabled very long and therefore is not very bright. To solve this problem, the display elements are driven in groups rather than one at a time. All elements whose cathode is connected to a single terminal should be driven simultaneously. This method eliminates all possible interference while solving the drive duty problem.

I claim:

1. An electrical display system consisting of a passive multi-element display using planar interconnect and a three state driver capable of individually addressing all display elements; planar means that there is only a single wiring plane with no crossing wires; three state means that each signal can be high, low, or off.

2. A display as part of the system defined in claim 1 in which all display elements are two-terminal devices and the number of individually addressable display elements is at least seven and more than double the number of terminals exiting from the planar interconnect to the driver.

3. A display as defined in claim 2 in which the planar interconnect is a quilt of smaller abutted tiles each having planar interconnect, and the number of individually addressable display elements in each additional tile beyond the first tile is at least double the number of additional signals connecting from that tile to the driver, and the quilt reuses at least one tile in at least two places.
